(19) United States
(12) Patent Application Publication
(10) Pub. No.: US 2009/0043044 A2
(43) Pub. Date: Feb. 12, 2009

(54) METHOD FOR PRODUCTION OF BEAD POLYMERS WITH AN AVERAGE PARTICLE SIZE IN THE RANGE OF 1 MICROMETER TO 40 MICROMETERS AND MOULDED MASSES AND MOULDED BODIES COMPRISING BEAD POLYMERS

(75) Inventors: Sabine SCHWARZ-BARAC, Riedstadt (DE); Klaus SCHULTES, Wiesbaden (DE); Michael SCHNABEL, Biebesheim (DE); Stefan NAU, Buettelborn (DE); Ursula GOLCHERT, Dieburg (DE)

Correspondence Address: OBLON, SPIVAK, MCCLELLAND MAIER & NEUSTADT, P.C., 1940 DUKE STREET, ALEXANDRIA, VA, 22314, UNITED STATES, 703-413-3000, 703-413-2220, patentdocket@oblon.com

(73) Assignee: EVONIK ROEHM GMBH, Darmstadt (DE)

(21) Appl. No.: 11/913,325

(22) Filed: Nov. 1, 2007

(30) Foreign Application Priority Data
May 4, 2005 (DE) 10 2005 021 335.9

(51) Int. Cl. C08K 3/10

(52) U.S. Cl. 524/786

(57) ABSTRACT

Process for preparation of bead polymers whose average particle size is in the range from 1 μm to 40 μm, by dispersing and polymerizing a polymerizable composition in an aqueous phase, where the dispersion stabilized by an aluminium compound is prepared at a shear rate ≧10³ s⁻¹. A polymerizable composition is used here which, in each case based on its total weight, comprises
a) more than 50.0% by weight of at least one compound of the formula (I), 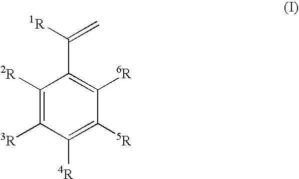
where the radicals ¹R to ⁶R have definitions according to the Description, b) from 0.1% by weight to 10.0% by weight of at least one crosslinking agent and
   c) less than 49.9% by weight of at least one compound of the formula (II) 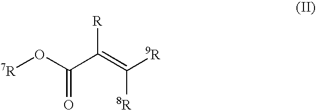
where the radicals R and ⁷R to ⁹R have definitions according to the Description The bead polymers prepared according to the inventive process are particularly suitable for production of mouldings with light-scattering properties.

The present invention relates to processes for preparation of bead polymers whose average particle size is in the range from 1 μm to 40 μm, by dispersing and polymerizing a polymerizable composition in an aqueous phase. The present invention further relates to moulding compositions and mouldings which comprise the inventively prepared bead polymers.

Various applications require bead polymers whose particle diameter is of the order of size of from 1 μm to 40 μm with relatively narrow particle size distribution. One of the uses of these beads, among others, is as additives for PMMA moulding compositions.

A particular application sector here is that of light-scattering moulding compositions. In this sector, standard moulding compositions are blended with what are known as scattering beads, which have crosslinking and whose refractive index differs from that of the matrix. Materials currently used in these moulding compositions are scattering particles based on PMMA whose particle size is well above 40 μm. The advantage of these scattering particles is the high degree of forward scattering of the mouldings once the scattering particles have been incorporated into the moulding compositions. Because the loss via backward scattering is smaller, the result here is substantially higher luminous efficiency when comparison is made with traditional opacifiers, e.g. BaSO₄ or TiO₂, at a high level of scattering. This preferred forward scattering can be determined via measurement of transmittance in combination with the halved-energy angle or halved-intensity angle of mouldings comprising scattering beads.

The smaller the particle size of the scattering beads, the higher the level of scattering effect for an identical proportion by weight in the moulding composition. Use of smaller beads can therefore reduce their amount. This saves costs and conserves resources. Furthermore, the moulding compositions equipped with the smaller bead polymers exhibit excellent mechanical properties, because the reduced amount of scattering beads has a less marked effect on these properties. If scattering beads whose diameter is smaller than 5 μm are used, the resultant moulding compositions appear markedly more yellow.

Furthermore, the beads described above can also be used for matted moulding compositions and polyalkyl (meth)acrylate (PAMA) plastisols. However, these application sectors are not of prime importance in the present invention.

Polymer particles whose order of size is from 1 μm to 10 μm can be produced with good results by way of a precipitation polymerization reaction in which large amounts of organic solvents are used. However, the solvents used create problems of safety and disposal. There are also problems with work-up. Beads obtained in this way are therefore expensive and, for reasons of cost, are not used in the application sectors described above.

Polymer beads can be obtained via conventional suspension polymerization reaction at lower cost. However, the size of the resultant particles is generally greater than 40 μm, with broad distribution.

By way of example, European Patent Application EP 0 443 609 A2 discloses a suspension process for preparation of bead polymers by combining two separately introduced phases (monomers and continuous phase) into a mixing cell with a high level of shear energy and then polymerizing the monomers in a conventional reaction vessel. Various auxiliaries are mentioned for stabilization of the dispersion. Among these are, inter alia, inorganic substances, such as calcium phosphate, and organic compounds, such as cellulose derivatives or polyvinyl alcohol. EP 0 443 609 A2 does not describe the use of aluminium compounds.

Monomers used in EP 0 443 609 A2 are, inter alia, styrene and (meth)acrylates. The examples show polymerization of monomer mixtures which encompass 80% by weight of styrene and 20% by weight of butyl acrylate. The resultant polymer particles here have particle sizes in the range from 5 μm to 10 μm. EP 0 443 609 A2 does not describe the use of a crosslinking agent.

According to EP 0 443 609 A2, the polymer particles can in particular be used in the powder-production industry. However, they are not suitable for light-scattering moulding compositions because the non-crosslinked polymer particles would dissolve in the moulding composition to be prepared and would therefore be ineffective as light-scattering particles.

The specification DE 100 65 501 A1 discloses a process for preparation of bead polymers whose average particle size is in the range from 1 μm to 40 μm, by dispersing and polymerizing, in an aqueous phase, a polymerizable composition which comprises at least 50% by weight of (meth)acrylates. The dispersion, stabilized by an aluminium compound, is prepared at a shear rate ≧10³ s⁻¹.

The resultant bead polymers are used, inter alia, for production of mouldings with matt surface, and the mouldings shown in the associated examples have transmittance to DIN 5036 in the range from 76.3 to 91.1, yellowness index to DIN 6167 in the range from 2.9 to 9.4 and halved-energy angle in the range from 18.5 to 22.5. However, a higher level of scattering action is desirable for many applications.

In view of the prior art stated and discussed herein, it was therefore an object of the present invention to provide mouldings which scatter light more markedly which at the same time have maximum transparency and minimum yellowness index. The intention here was to achieve the improvement in scattering action in a manner which minimizes cost.

These objects, and also other objects which although not expressly mentioned can be derived in a self-evident manner from the circumstances discussed herein or are a necessary result of these circumstances, are achieved via mouldings obtainable from bead polymers which are obtainable via the process according to Claim 1. Accordingly, the present invention protects the process for preparation of the bead polymers, the bead polymers, the moulding compositions encompassing the bead polymers and the mouldings obtainable from the moulding compositions. The respective dependent subclaims describe particularly useful embodiments of the process, of the bead polymers, of the moulding compositions and of the mouldings.

Surprisingly, a process for preparation of high-specification bead polymers whose average particle size is in the range from 1 μm to 40 μm is provided, without use of large amounts of any organic solvent requiring disposal after the polymerization reaction, by dispersing and polymerizing a polymerizable composition composed as stated in Claim 1 in an aqueous phase, where the dispersion stabilized by an aluminium compound is prepared at a shear rate ≧10³ s⁻¹.

The inventive measures achieve in particular the following advantages, inter alia:
The inventive process permits filtration of the resultant bead polymers.
The polymerization process of the present invention can be carried out using commercially available systems.
According to the invention, the bead polymers can be obtained with relatively little safety risk, because the amounts of organic solvents used are zero or only minimal. This in particular can eliminate the liberation or handling of environmentally hazardous substances.
The bead polymers are extremely inexpensive.
Bead polymers prepared according to the invention exhibit a very high level of scattering action when incorporated into moulding compositions and moulded to give mouldings. They moreover feature low yellowness index, high transmittance and a large halved-intensity angle.

The average particle size of the bead polymers prepared for the purposes of the present invention is in the range from 1 μm to 40 μm, preferably in the range from 5 μm to 35 μm. The particle size is based on the particle diameter. This value can be obtained by way of example via laser extinction methods. A CIS particle analyser from L.O.T. GmbH can be used for this purpose, and the measurement method for determination of particle size is found in the user manual. This method is preferred. Particle size can also be determined via measurement and counting of the particles on appropriate scanning electron micrographs.

Particular embodiments of the inventively prepared bead polymers exhibit narrow size distribution. The standard deviation from the average particle diameter is particularly preferably ≦30 μm, very particularly preferably ≦20 μm and in particular ≦10 μm.

In particular embodiments of the inventive process, spherical bead polymers are prepared which exhibit no, or only very slight, coagulation, aggregation or agglomeration.

According to the invention, the bead polymers are prepared via polymerization of a composition which, in each case based on its total weight, comprises
more than 50.0% by weight, preferably from more than 50.0% by weight to 99.0% by weight, advantageously from 60.0% by weight to 98.5% by weight, very particularly preferably from 70.0% by weight to 94.3% by weight, in particular from 80.0% by weight to 90.0% by weight, of at least one compound of the formula (I), 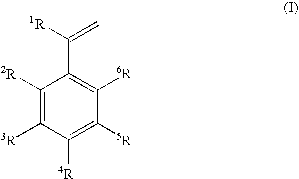
from 0.1% by weight to 10.0% by weight, preferably from 0.1% by weight to 5.0% by weight, advantageously from 0.5% by weight to 4.0% by weight, very particularly preferably from 0.7% by weight to 3.5% by weight, in particular from 1.0% by weight to 3.0% by weight, of at least one crosslinking agent and
less than 49.9% by weight, preferably from 0.9% by weight to less than 49.9% by weight, advantageously from 1.0% by weight to 40.0% by weight, very particularly preferably from 5.0% by weight to 30.0% by weight, in particular from 9.0% by weight to 19.0% by weight, of at least one compound of the formula (II) 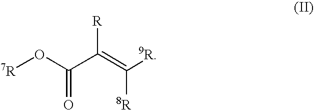
   The radical ¹R is hydrogen or a linear or branched alkyl group having from 1 to 6 carbon atoms, preferably hydrogen, methyl or ethyl, in particular hydrogen.

Each of the radicals ²R to ⁶R is, independently of the others, hydrogen, a linear or branched alkyl group having from 1 to 6 carbon atoms or a halogen. Particularly preferred alkyl groups have from 1 to 4 carbon atoms, advantageously 1 or 2 carbon atoms, in particular 1 carbon atom, and encompass in particular methyl, ethyl and isopropyl. Particularly preferred halogens are chlorine and bromine. For the purposes of one very particularly advantageous embodiment, all of the radicals ²R to ⁶R are hydrogen.

The radical R is hydrogen or methyl.

The radical ⁷R is a linear or branched alkyl group or an optionally alkylated cycloalkyl group having from 1 to 40, preferably from 1 to 24, advantageously from 1 to 12, particularly preferably from 1 to 6, in particular from 1 to 4, carbon atoms.

Each of the radicals ⁸R and ⁹R is, independently of the others, hydrogen or a group of the formula —COOR′, where R′ is hydrogen or an alkyl group having from 1 to 40, preferably from 1 to 24, advantageously from 1 to 12, particularly preferably from 1 to 6, in particular from 1 to 4, carbon atoms.

Particularly advantageous compounds of the formula (I) for the purposes of the present invention encompass in particular styrene, substituted styrenes having an alkyl substituent in the side chain, e.g. α-methylstyrene and a-ethylstyrene, substituted styrenes having an alkyl substituent on the ring, e.g. vinyltoluene and p-methylstyrene, halogenated styrenes, e.g. monochlorostyrenes, dichlorostyrenes, tribromostyrenes and tetrabromostyrenes.

Among the particularly preferred compounds of the formula (II) are in particular (meth)acrylates, fumarates and maleates which derive from saturated alcohols, e.g. methyl (meth)acrylate, ethyl (meth)acrylate, n-propyl (meth)acrylate, isopropyl (meth)acrylate, n-butyl (meth)acrylate, tert-butyl (meth)acrylate, pentyl (meth)acrylate, hexyl (meth)acrylate, 2-ethylhexyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, cetyleicosyl (meth)acrylate, stearyleicosyl (meth)acrylate, docosyl (meth)acrylate and/or eicosyltetratriacontyl (meth)acrylate;

cycloalkyl (meth)acrylates, such as cyclopentyl (meth)acrylate, 2,3,4,5-tetra-tert-butylcyclohexyl (meth)acrylate, cyclohexyl (meth)acrylate, bornyl (meth)acrylate;

and also the corresponding fumarates and maleates.

The ester compounds with long-chain alcohol radical, in particular the compounds having alcohol radicals having 6 or more carbon atoms, can by way of example be obtained via reaction of (meth)acrylates, fumarates, maleates and/or the corresponding acids with long-chain fatty alcohols, the product generally being a mixture of esters, e.g. (meth)acrylates having various long-chain alcohol radicals. Among these fatty alcohols are, inter alia, Oxo Alcohol® 7911, Oxo Alcohol® 7900, Oxo Alcohol® 1100, Alfol® 610, Alfol® 810, Lial® 125 and Nafol® grades (Sasol Olefins & Surfactants GmbH); Alphanol® 79 (ICI); Epal® 610 and Epal® 810 (Ethyl Corporation); Linevol® 79, Linevol® 911 and Neodol® 25E (Shell AG); Dehydad®, Hydrenol® and Lorol® grades (Cognis); Acropol® 35 and Exxal® 10 (Exxon Chemicals GmbH); Kalcol 2465 (Kao Chemicals).

Among the compounds of the formula (II), the (meth)acrylates are particularly preferred over the maleates and fumarates, i.e. ⁸R and ⁹R are hydrogen in particularly preferred embodiments. The methacrylates are generally preferred over the acrylates.

For the purposes of the present invention, the term (meth)acrylate encompasses methacrylates and acrylates and also mixtures composed of the two.

According to the invention, there are no particular restrictions on the nature of the crosslinking agent. In fact, it is possible to use any of the compounds which are known for crosslinking in free-radical polymerization and which can be copolymerized with the compounds of the formula (I) and (II).

Among these are in particular
(a) difunctional (meth)acrylates, preferably
   compounds of the general formula: 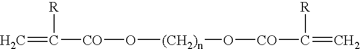
      where R is hydrogen or methyl and n is a positive whole number greater than or equal to 2, preferably from 3 to 20, in particular di(meth)acrylates of propanediol, of butanediol, of hexanediol, of octanediol, of nonanediol, of decanediol and of eicosanediol;
   compounds of the general formula: 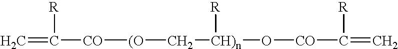
      where R is hydrogen or methyl and n is a positive whole number from 1 to 14, in particular di(meth)acrylates of ethylene glycol, of diethylene glycol, of triethylene glycol, of tetraethylene glycol, of dodecaethylene glycol, of tetradecaethylene glycol, of propylene glycol, of dipropyl glycol and of tetradecapropylene glycol.
   Glycerol di(meth)acrylate, 2,2′-bis[β-(γ-methacryloxy-β-hydroxypropoxy)-phenylpropane] or bis-GMA, bisphenol A dimethacrylate, neopentyl glycol di(meth)acrylate, 2,2′-di(4-methacryloxypolyethoxyphenyl)propane having from 2 to 10 ethoxy groups per molecule and 1,2-bis(3-methacryloxy-2-hydroxypropoxy)butane.
(b) tri- or polyfunctional (meth)acrylates, in particular trimethylolpropane tri(meth)acrylates and pentaerythritol tetra(meth)acrylate.
(c) graft-linking agent having at least two carbon-carbon double bonds of different reactivity, in particular allyl methacrylate and allyl acrylate;
(d) aromatic crosslinking agents, in particular 1,2-divinylbenzene, 1,3-divinylbenzene and 1,4-divinylbenzene.

For the purposes of the present invention, the following compounds have proven particularly successful:

(meth)acrylates which derive from unsaturated alcohols, e.g. oleyl (meth)acrylate, allyl (meth)acrylate, vinyl (meth)acrylate, 2,4,5-tri-tert-butyl-3-vinylcyclohexyl (meth)acrylate, 3-vinylcyclohexyl (meth)acrylate; methacrylates of unsaturated ether alcohols, e.g. vinyloxyethoxyethyl methacrylate, 1-methyl(2-vinyloxy)ethyl methacrylate, allyloxymethyl methacrylate;

polyfunctional (meth)acrylates, such as trimethylolpropane tri(meth)acrylate, glycol di(meth)acrylate, bis((meth)acryloyloxyethyl)sulphide; and dienes, such as divinylbenzene.

It is particularly preferable to use glycol di(meth)acrylate.

Preferred mixtures for preparation of preferred bead polymers can moreover encompass in particular ethylenically unsaturated monomers which can be copolymerized with the compounds of the formulae (I) and/or (II). The proportion of comonomers is preferably in the range from 0.01 to 25.0% by weight, with preference in the range from 0.01 to 10.0% by weight, particularly preferably in the range from 0.01 to 5.0% by weight, in particular in the range from 0.01 to 1.0% by weight, based on the total weight of the monomer composition.

Comonomers particularly suitable here for the polymerization reaction according to the present invention have the formula: 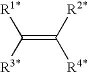
where R¹* and R²* have been selected independently from the group consisting of hydrogen, halogens, CN, linear or branched alkyl groups having from 1 to 20, preferably from 1 to 6 and particularly preferably from 1 to 4, carbon atoms, which may have from 1 to (2n+1) halogen atoms as substituent, where n is the number of carbon atoms of the alkyl group (e.g. CF₃), cycloalkyl groups having from 3 to 8 carbon atoms, which may have from 1 to (2n−1) halogen atoms, preferably chlorine, as substituent, where n is the number of carbon atoms of the cycloalkyl group; aryl groups having from 6 to 24 carbon atoms, which may have from 1 to (2n−1) halogen atoms, preferably chlorine, and/or alkyl groups having from 1 to 6 carbon atoms, as substituent, where n is the number of carbon atoms of the aryl group; C(═Y*)R⁵*, C(═Y*)NR⁶*R⁷*, Y*C(═Y*)R⁵*, SOR⁵*, SO₂R⁵*, OSO₂R⁵*, NR⁸*SO₂R⁵*, PR⁵*₂, P(═Y*)R⁵*₂, Y*PR⁵*₂, Y*P(═Y*)R⁵*_{, NR}⁸*₂ which may have been quaternized with an additional R⁸*, aryl or heterocyclyl group, where Y* can be NR⁸*, S or O, preferably O; R⁵* is an alkyl group having from 1 to 20 carbon atoms, an alkylthio group having from 1 to 20 carbon atoms, OR¹⁵ (R¹⁵ being hydrogen or an alkali metal), alkoxy of from 1 to 20 carbon atoms, aryloxy or heterocyclyloxy; R⁶* and R⁷* independently, are hydrogen or an alkyl group having from 1 to 20 carbon atoms, and R⁸* is hydrogen, or linear or branched alkyl or aryl groups having from 1 to 20 carbon atoms;

R³* and R⁴* have been selected independently from the group consisting of hydrogen, halogen (preferably fluorine or chlorine), alkyl groups having from 1 to 6 carbon atoms and COOR⁹*, where R⁹* is hydrogen, an alkali metal or an alkyl group having from 1 to 40 carbon atoms, or R³* and R⁴* can together form a group of the formula (CH₂)_{n′}, which may have from 1 to 2n′ halogen atoms or C₁-C₄ alkyl groups as substituent, or of the formula C(═O)—Y*—C(═O), where n′ is from 2 to 6, preferably 3 or 4, and Y* is defined as above; and where at least two of the radicals R¹*, R²*, R³* and R⁴* are hydrogen or halogen.

Among the preferred comonomers are, inter alia, vinyl halides, such as vinyl chloride, vinyl fluoride, vinylidene chloride and vinylidene fluoride; vinyl esters, such as vinyl acetate;

heterocyclic vinyl compounds, such as 2-vinylpyridine, 3-vinylpyridine, 2-methyl-5-vinyl pyridine, 3-ethyl-4-vinyl pyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinyloxazoles and hydrogenated vinyloxazoles;

vinyl and isoprenyl ethers;

maleic acid and maleic acid derivatives, such as maleic anhydride,

methylmaleic anhydride, maleimide, methyl maleimide;

fumaric acid and fumaric acid derivatives;

acrylic acid and methacrylic acid;

aryl (meth)acrylates, such as benzyl methacrylate or phenyl methacrylate, where the aryl radicals are each unsubstituted or substituted up to four times; methacrylates of halogenated alcohols, such as 2,3-dibromopropyl methacrylate, 4-bromophenyl methacrylate, 1,3-dichloro-2-propyl methacrylate, 2-bromoethyl methacrylate, 2-iodoethylmethacrylate, chloromethyl methacrylate;

hydroxyalkyl (meth)acrylates, such as 3-hydroxypropyl methacrylate, 3,4-dihydroxybutyl methacrylate, 2-hydroxyethyl methacrylate, 2-hydroxypropyl methacrylate, 2,5-dimethyl-1,6-hexanediol (meth)acrylate, 1,10-decanediol (meth)acrylate;

carbonyl-containing methacrylates, such as 2-carboxyethyl methacrylate, carboxymethyl methacrylate, oxazolidinylethyl methacrylate, N-(methacryloyloxy)formamide, acetonyl methacrylate, N-methacryloylmorpholine, N-methacryloyl-2-pyrrolidinone, N-(2-methacryloyloxyethyl)-2-pyrrolidinone, N-(3-methacryloyloxypropyl)-2-pyrrolidinone, N-(2-methacryloyloxypentadecyl)-2-pyrrolidinone, N-(3-methacryloyloxyheptadecyl)-2-pyrrolidinone; glycol methacrylates, such as 1,2-butanediol methacrylate, 2-butoxyethyl methacrylate, 2-ethoxyethoxymethyl methacrylate, 2-ethoxyethyl methacrylate; methacrylates of ether alcohols, e.g. tetrahydrofurfuryl methacrylate, methoxyethoxyethyl methacrylate, 1-butoxypropyl methacrylate, cyclohexyloxymethyl methacrylate, methoxymethoxyethyl methacrylate, benzyloxymethyl methacrylate, furfuryl methacrylate, 2-butoxyethyl methacrylate, 2-ethoxyethoxymethyl methacrylate, 2-ethoxyethyl methacrylate, 1-ethoxybutyl methacrylate, methoxymethyl methacrylate, 1-ethoxyethyl methacrylate, ethoxymethyl methacrylate and ethoxylated (meth)acrylates which preferably have from 1 to 20, in particular from 2 to 8, ethoxy groups; aminoalkyl (meth)acrylates and aminoalkyl(meth)acrylamides, e.g. N-(3-dimethylaminopropyl)methacrylamide, dimethylaminopropyl methacrylate, 3-d iethylaminopentyl methacrylate, 3-d ibutylaminohexadecyl (meth)acrylate; nitriles of (meth)acrylic acid and other nitrogen-containing methacrylates, e.g. N-(methacryloyloxyethyl)diisobutyl ketimine,

N-(methacryloyloxyethyl)dihexadecyl ketimine, methacryloylamidoacetonitrile, 2-methacryloyloxyethylmethylcyanamide, cyanomethyl methacrylate; heterocyclic (meth)acrylates, such as 2-(1-imidazolyl)ethyl (meth)acrylate, 2-(4-morpholinyl)ethyl (meth)acrylate and 1-(2-methacryloyloxyethyl)-2-pyrrolidone;

oxiranyl methacrylates, such as 2,3-epoxybutyl methacrylate, 3,4-epoxybutyl methacrylate, 10,11-epoxyu ndecyl methacrylate, 2,3-epoxycyclohexyl methacrylate, 10,11-epoxyhexadecyl methacrylate; glycidyl methacrylate.

These monomers can be used individually or in the form of a mixture.

The polymerization reaction is generally initiated by known free-radical initiators. Among the preferred initiators are, inter alia, the azo initiators well known to persons skilled in the art, e.g. AIBN and 1,1-azobiscyclohexanecarbonitrile, and also peroxy compounds, such as methyl ethyl ketone peroxide, acetylacetone peroxide, dilauroyl peroxide, tert-butyl 2-ethylperhexanoate, ketone peroxide, methyl isobutyl ketone peroxide, cyclohexanone peroxide, dibenzoyl peroxide, tert-butyl peroxybenzoate, tert-butyl isopropyl peroxycarbonate, 2,5-bis(2-ethylhexanoylperoxy)-2,5-dimethylhexane, tert-butylperoxy 2-ethylhexanoate, tert-butylperoxy 3,5,5-trimethylhexanoate, d icu myl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl)peroxydicarbonate, mixtures of two or more of the abovementioned compounds with one another, and also mixtures of the abovementioned compounds with compounds not mentioned above which can likewise form free radicals.

The amount used of these compounds is often from 0.1 to 10.0% by weight, preferably from 0.5 to 3.0% by weight, based on the total weight of the monomers.

The water:monomer ratio is usually in the range from 0.4:1 to 20:1, preferably from 2:1 to 8:1, based on the weight of the components.

In order to stabilize the dispersion, it is necessary to use aluminium compounds sparingly soluble in water. Among these are in particular aluminium oxide Al₂O₃ and aluminium hydroxide Al(OH)₃, preference being given to Al(OH)₃. Aluminium hydroxide of particular interest is prepared via precipitation, and the time between this precipitation and subsequent formation of the dispersion should be minimized. In particular embodiments of the inventive process, the precipitation takes place within 2 hours, preferably within a period of 1 hour, and very particularly preferably within a period of 30 minutes, prior to formation of the dispersion.

By way of example, Al₂(SO₄)₃ can be dissolved in water. This solution can then be treated with a sodium carbonate solution until the pH is in the range from 5 to 5.5. This procedure gives a particularly preferred colloidal dispersion of the aluminium compound in water.

The amount of aluminium compound used is from 0.5 to 200.0% by weight, particularly preferably from 3.0 to 100.0% by weight and very particularly preferably from 4.0 to 20.0% by weight, based on the total weight of the monomers used. If smaller amounts are used, there is a risk of obtaining merely an unstable dispersion and a phase separation occurs, or at least formation of relatively large aggregates. If the amounts used are larger, there is a risk that it will be impossible to produce a uniform dispersion.

Other processes of particular interest are those in which other auxiliaries are used alongside the aluminium compound for stabilization. Among these are in particular surfactants, such as anionic, cationic and neutral emulsifiers.

Examples of anionic emulsifiers are alkali metal salts of higher fatty acids having from 8 to 30 carbon atoms, such as palmitic, stearic and oleic acid, alkali metal salts of sulphonic acids having by way of example from 8 to 30 carbon atoms, in particular sodium salts of alkyl- or arylalkylsulphonic acids, alkali metal salts of half-esters of phthalic acid, and alkali metal salts of resin acids, such as abietic acid.

Among cationic emulsifiers are, inter alia, salts of long-chain, in particular unsaturated, amines having from 10 to 20 carbon atoms, or quaternary ammonium compounds having relatively long-chain olefin or paraffin radicals. Examples of neutral emulsifiers are ethoxylated fatty alcohols, ethoxylated fatty acids and ethoxylated phenols and fatty acid esters of polyhydric alcohols, such as pentaerythritol or sorbitol.

The amounts used of the abovementioned emulsifiers are preferably in the range from 0.0 to 5.0% by weight, particularly preferably from 0.3 to 3.0% by weight, based on the weight of aluminium compound.

It is moreover possible for the conventional additives and auxiliaries to be added to the mixture prior to, during or after formation of the dispersion. Among these are in particular substances which give the particles particular properties, e.g. polymers, dyes and pigments, if appropriate having ferromagnetic properties. Complexing agents, such as EDTA or Trilon A, and compounds, such as polyethylene glycol, which inhibit formation of tank deposit can moreover be used.

For the purposes of the present invention, the dispersion process takes place at a shear rate ≧10³ s⁻¹. The shear rate is preferably in the range from 10⁴ s⁻¹ to 10⁵ s⁻¹. At shear rates <10³ s⁻¹ the particle size of the resultant bead polymer is greater than 40 μm. The shear rate can be defined as a value obtained by dividing the absolute value of the velocity difference of two planes by the distance between the two planes, the mixture to be dispersed here being in the space between the two planes, the separation between which is up to 6 mm.

The dispersion can be prepared by any process suitable for this purpose. Dispersers known to the person skilled in the art are generally used for this purpose. Among these are Dispermat, VMA-Getzmann, Reichshof; Ultra-Turrax, Janke and Kunkel, Staufen and pressure homogenizer, Gaulin, Lübeck. There are also known devices using a rotor-stator system, for example Dispax, Janke and Kunkel, Staufen; Cavitron homogenizers, V. Hagen & Funke, Sprochhövel; homogenizers from Kotthoff, Essen and homogenizers from Doee Oliver, Grevenbroich. These devices are usually operated at rotation rates of from 1000 to 25 000 rpm, preferably from 2000 to 25 000 rpm. Other ways of generating the high shear forces required to form the dispersion are exposure to ultrasound, use of high pressure to discharge the mixture to be dispersed through a narrow gap or through small-diameter nozzles, or use of colloid mills.

Dispersion of the monomers and of the other constituents of the reaction mixture generally takes place at temperatures in the range from 0 to 100° C., preferably in the range from 20 to 60° C., with no restriction thereto.

The dispersion time can be in a wide range as a function of the desired diameter of the monomer droplets, of the size distribution to be established and of the quantitative proportions of the constituents of the mixture. The dispersion can generally be prepared within a period of a few hours.

The dispersion process generally takes place prior to the start of the polymerization reaction. However, in particular at the start at the polymerization reaction, the dispersion can be exposed to a high shear force, in order to eliminate any possible formation of relatively large aggregates. On the other hand, the polymerization reaction should take place soon after formation of the dispersion. Surprisingly, however, it has been found that the dispersion stabilized by the aluminium compound can be stored for a relatively long period. This property makes it easier to use conventional polymerization systems, because, unlike in many conventional processes, there is no requirement for exposure to shear forces at the start of the polymerization reaction.

The polymerization reaction can be carried out at atmospheric pressure, or subatmospheric or superatmospheric pressure. Neither is the polymerization temperature critical. However, as a function of the initiator system used, it is generally in the range from 0° to 200° C., preferably from 40° to 130° C. and particularly preferably from 60° to 120° C., with no intended resultant restriction.

Once the polymerization reaction has ended, the aluminium compound can be converted into a water-soluble form, for example via addition of sulphuric or hydrochloric acid. The bead polymer can be isolated via pressure filtration from the water without difficulty. If known organic compounds are used instead of the aluminium compound significant according to the invention for stabilization of the dispersion, this type of filtration is prevented by the rheological properties of the mixture.

The bead polymers obtained according to the process described above are used in particular in moulding compositions, which are likewise provided by this invention. Suitable matrix polymers are any of the thermoplastically processible polymers known for this purpose. Among these are, inter alia, polyalkyl (meth)acrylates, such as polymethyl methacrylate (PMMA), polyacrylonitriles, polystyrenes, polyethers, polyesters, polycarbonates, polyvinyl chlorides. Among these, preference is given to polyalkyl (meth)acrylates. These polymers can be used individually or else in the form of a mixture. These polymers can also be present in the form of copolymers.

The refractive indices of the matrix polymer and of the bead polymer are advantageously different from one another, their difference preferably being at least 0.02.

The content of the bead polymer, based on the total weight of the moulding composition, is advantageously from 0.1% by weight to 20.0% by weight, preferably from 1.0% by weight to 15.0% by weight, with advantage from 3.0% by weight to 10.0% by weight, in particular from 4.0 to 8.0% by weight.

The moulding compositions can comprise conventional additives of any type. Among these are, inter alia, antistatic agents, antioxidants, mould-release agents, flame retardants, lubricants, dyes, flow improvers, fillers, light stabilizers and organophosphorus compounds, such as phosphites or phosphonates, pigments, weathering stabilizers and plasticizers.

Known processes, such as extrusion, can be used to produce mouldings with light-scattering properties from the moulding compositions described above. The transmittance to DIN 5036 of these mouldings is advantageously greater than 40.0%, preferably greater than 45.0%, in particular greater than 50.0%. The halved-intensity angle (β) of the mouldings is advantageously in the range from 35.00 to less than 90.0°, preferably in the range from 50.0° to less than 90.0°, in particular in the range from 72.00 to less than 90.0°. The mouldings moreover advantageously feature a yellowness index to DIN 6167 smaller than 10.0%, preferably smaller than 9.5%, in particular smaller than 9.0%.

If there is no refractive index difference between the matrix and the scattering beads, the result is mouldings with a matt surface.

Inventive examples and comparative examples are used below to provide more detailed illustration of the invention, but there is no intention that the invention be restricted to these inventive examples.

Scattering Beads A and C-F

To prepare the suspension polymer, an aluminium hydroxide Pickering stabilizer is used, prepared via precipitation from aluminium sulphate and soda solution immediately prior to the start of the actual polymerization reaction. For this, 16 g of Al₂(SO₄)₃, 0.032 g of complexing agent (Trilon A) and 0.16 g of emulsifier (K30 emulsifier obtainable from Bayer AG; sodium salt of a C₁₅-paraffinsulphonate) were first dissolved in 0.8 l of distilled water. A 1 N sodium carbonate solution was then added, with stirring, at a temperature of about 40° C. to the aluminium sulphate dissolved in water, whereupon the pH was then in the range from 5 to 5.5. This procedure gave a colloidal dispersion of the stabilizer in water. In order to prevent tank-wall deposit, polyethylene glycol (molar mass from 5000 to 6000 g/mol) is then added to the dispersing-agent-precipitation process.

Once the stabilizer had been precipitated, the aqueous phase was transferred to a glass beaker. 200 g of a monomer mixture whose composition is stated in Table 1, and also 4 g of dilauroyl peroxide, 0.4 g of tert-butyl 2-ethyl-perhexanoate and 1.6 g of ammonium peroxodisulphate were added thereto. This mixture was dispersed for 15 minutes at 7000 rpm by means of a disperser (Ultra-Turrax S50N-G45MF, Janke and Kunkel, Staufen).

Following the shear process, the reaction mixture was charged to the reactor, which was preheated to the appropriate reaction temperature of 90° C., and was polymerized at about 90° C. (polymerization temperature) for 45 minutes (polymerization time) with stirring (600 rpm). A post-reaction phase of 1 hour at about 85° C. internal temperature followed. After cooling to 45° C., the stabilizer was converted into water-soluble aluminium sulphate via addition of 50% strength sulphuric acid. For work-up of the beads, the resultant suspension was filtered through a commercially available filter fabric and the product was dried at 50° C. for 24 hours in a heated cabinet.

Size distribution was studied via laser extinction methods to determine average size V₅₀ and the associated standard deviation. The results are collated in Table 1. The shape of the beads was spherical, and no fibres could be found. No coagulation occurred.

Scattering beads G and H

The preparation method followed the polymerization specification for scattering beads A and C-F, except that the monomer mixtures stated in Table 1 were used and no Pickering stabilizer was added.

The size distribution of the resultant bead polymers is likewise stated in Table 1.

Scattering beads B

The preparation method was substantially the same as the polymerization specification for scattering beads A and C-F, but in each case 200 times the amounts of the constituents were used. This required adoption of some changes on technical grounds. The precipitated Pickering stabilizer was used as initial charge with monomers, initiator and additives in the reactor and dispersion was then achieved at a temperature of 40° C. with the aid of a through-flow disperser (Dispax-Reaktor, Janke and Kunkel). For this, the mixture was cycled through the disperser for 30 minutes, and within the reactor the dispersion was stirred at 150 rpm by a conventional stirrer.

After 30 minutes, the dispersion was heated to 80° C. The polymerization reaction and work-up followed the polymerization specification for scattering beads A and C-F.

The size distribution of the resultant bead polymer is likewise stated in Table 1.

TABLE 1

| | Methyl | | Glycol | | |
|---|---|---|---|---|---|
| Scattering | methacrylate | Styrene | dimethacrylate | V₅₀ | σ |
| beads | [% by wt.] | [% by wt.] | [% by wt.] | [μm] | [μm] |
| A | 13.0 | 85.0 | 2.0 | 30 | 25 |
| B | 13.0 | 85.0 | 2.0 | 30 | 45 |
| C | 28.0 | 70.0 | 2.0 | 32 | 24 |
| D | 35.5 | 62.5 | 2.0 | 30 | 25 |
| E | 48.0 | 50.0 | 2.0 | 25 | 26 |
| F | 0.0 | 98.0 | 2.0 | 22 | 24 |
| G | 13.0 | 85.0 | 2.0 | 53 | 42 |
| H | 69.0 | 30.0 | 1.0 | 74 | 77 |

Light-Scattering Test Specimens For further investigation, a standard PMMA moulding composition (PLEXIGLAS® 7N obtainable from Röhm GmbH) was modified with the amounts stated in Table 2 of scattering beads A-H. These moulding compositions were used to produce test specimens of dimension 60 mm×45 mm×3 mm via injection moulding, and the transmittance (T) of these to DIN 5036 was determined, as were their yellowness index (Y) to DIN 6167 and halved-intensity angle (β) measured to DIN 5036, using a GO-T-1500 goniometer test unit from LMT.

The resultant data are shown in Table 2.

TABLE 2

| | | Content of | | | |
|---|---|---|---|---|---|
| | | scattering | | | |
| | Scattering | beads | | | |
| | beads | [% by wt.] | T [%] | Y [%] | β [°] |
| Inventive example 1 | A | 4 | 57.19 | 8.84 | 71.42 |
| Inventive example 2 | A | 6 | 52.19 | 8.26 | 77.60 |
| Inventive example 3 | A | 9 | 48.31 | 9.48 | 78.15 |
| Inventive example 4 | A | 12 | 44.79 | 11.97 | 80.25 |
| Inventive example 5 | B | 4 | 61.28 | 10.27 | 47.50 |
| Inventive example 6 | B | 6 | 53.32 | 9.62 | 77.25 |
| Inventive example 7 | B | 9 | 48.15 | 11.96 | 79.41 |
| Inventive example 8 | B | 12 | 45.88 | 14.30 | 79.23 |
| Inventive example 9 | C | 3 | 64.06 | 9.86 | 45.02 |
| Inventive example 10 | C | 6 | 52.79 | 8.21 | 78.86 |
| Inventive example 11 | C | 9 | 51.07 | 9.03 | 79.77 |
| Inventive example 12 | C | 12 | 49.19 | 10.81 | 79.37 |
| Inventive example 13 | D | 6 | 63.00 | 8.90 | 54.33 |
| Inventive example 14 | E | 6 | 69.00 | 9.43 | 39.13 |
| Inventive example 15 | F | 2 | 60.85 | 9.73 | 50.53 |
| Inventive example 16 | F | 4 | 50.41 | 8.78 | 77.93 |
| Inventive example 17 | F | 6 | 50.41 | 9.69 | 78.25 |
| Comparative example 1 | G | 6 | 55.81 | 9.68 | 71.32 |
| Comparative example 2 | H | 6 | 92.04 | 1.27 | 10.98 |

The test results in Table 2 show that when the scattering beads prepared according to the process of the present invention are compounded into moulding compositions (inventive examples 1-17), they scatter light very effectively without any great loss of energy. The scattering beads whose styrene content is 85% by weight have the highest level of scattering action here. Although scattering beads whose styrene content is lower or higher achieve a high halved-intensity angle, this falls off more rapidly with reducing concentration of the scattering beads in the moulding composition.

1. A process for preparation of bead polymers whose average particle size is in the range from 1 μm to 40 μm, by dispersing and polymerizing a polymerizable composition in an aqueous phase, where the dispersion stabilized by an aluminium compound is prepared at a shear rate ≧10³ s⁻¹, wherein a polymerizable composition is used which, in each case based on its total weight, comprises
a) more than 50.0% by weight of at least one compound of the formula (I), 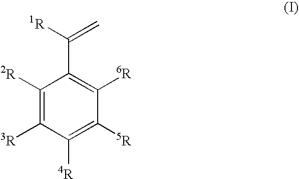
where ¹R is hydrogen or a linear or branched alkyl group having from 1 to 6 carbon atoms and each of the radicals ²R to ⁶R is, independently of the others, hydrogen, a linear or branched alkyl group having from 1 to 6 carbon atoms, or a halogen,
b) from 0.1% by weight to 10.0% by weight of at least one crosslinking agent and
c) less than 49.9% by weight of at least one compound of the formula (II) 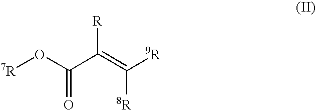
where R is hydrogen or methyl, ⁷R is a linear or branched alkyl group or an optionally alkylated cycloalkyl group having from 1 to 40 carbon atoms and the radicals ⁸R and ⁹R, in each case independently of each other, are hydrogen or a group of the formula COOR′, where R′ is hydrogen or an alkyl group having from 1 to 40 carbon atoms.

2. The process according to claim 1, wherein the polymerizable composition used, in each case based on its total weight, comprises
from more than 50.0% by weight to 99.0% by weight of at least one compound of the formula (I),
from 0.1% by weight to 5.0% by weight of at least one crosslinking agent and
from 0.9% by weight to less than 49.9% by weight of at least one compound of the formula (II).

3. The process according to claim 1, wherein the polymerizable composition used, in each case based on its total weight, comprises
from 60.0% by weight to 98.5% by weight of at least one compound of the formula (I),
from 0.5% by weight to 4.0% by weight of at least one crosslinking agent and
from 1.0% by weight to 40.0% by weight of at least one compound of the formula (II).

4. The process according to claim 1, wherein the polymerizable composition used, in each case based on its total weight, comprises
from 70.0% by weight to 94.3% by weight of at least one compound of the formula (I),
from 0.7% by weight to 3.5% by weight of at least one crosslinking agent and
from 5.0% by weight to 30.0% by weight of at least one compound of the formula (II).

5. The process according to claim 1, wherein the polymerizable composition used, in each case based on its total weight, comprises
from 80.0% by weight to 90.0% by weight of at least one compound of the formula (I),
from 1.0% by weight to 3.0% by weight of at least one crosslinking agent and
from 9.0% by weight to 19.0% by weight of at least one compound of the formula (II).

6. The process according to claim 1, wherein Al(OH)₃ is used for stabilization.

7. The process according to claim 6, wherein the Al(OH)₃ is prepared via precipitation.

8. The process according to claim 1, wherein the concentration of the aluminium compound, based on the weight of the polymerizable composition, is in the range from 0.5% by weight to 200.0% by weight.

9. The process according to claim 1, wherein the concentration of the aluminium compound, based on the weight of the polymerizable composition, is in the range from 3.0% by weight to 100.0% by weight.

10. The process according to claim 1, wherein the concentration of the aluminium compound, based on the weight of the polymerizable composition, is in the range from 4.0% by weight to 20.0% by weight.

11. The process according to claim 1, wherein the average particle size of the bead polymers is in the range from 5 μm to 35 μm.

12. The process according to claim 1, wherein an emulsifier is also used.

13. The process according to claim 12, wherein the concentration of the emulsifier, based on the weight of the aluminium compound, is in the range from 0.0% by weight to 5.0% by weight.

14. The process according to claim 12, wherein the concentration of the emulsifier, based on the weight of the aluminium compound, is in the range from 0.3% by weight to 3.0% by weight.

15. The process according to claim 1, wherein the dispersion obtained after the polymerization reaction is filtered.

16. A bead polymer, prepared by the process according to claim 1.

17. A moulding composition, comprising at least one bead polymer according to claim 16.

18. A moulding with light-scattering properties, comprising at least one bead polymer according to claim 16.

19. The moulding according to claim 18, whose transmittance to DIN 5036 is greater than 40.0%.

20. The moulding according to claim 18, characterized in that its halved-intensity angle (β) is in the range from 35.0° to less than 90.0°.

21. The moulding according to claim 18, wherein its yellowness index to DIN 6167 is smaller than 10.0%.
